(19) United States
(12) Patent Application Publication
(10) Pub. No.: US 2009/0121471 A1
(43) Pub. Date: May 14, 2009

(54) METHOD AND SYSTEM FOR PRODUCING DOCUMENTS, WEBSITES, AND THE LIKE HAVING SECURITY FEATURES

(76) Inventors: Gene F. Gaffney, Wantagh, NY (US); William R. O'Brien, Queens Village, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/019,304

(22) Filed: Jan. 24, 2008

Related U.S. Application Data
(63) Continuation-in-part of application No. 11/678,318, filed on Feb. 23, 2007.
(60) Provisional application No. 60/887,439, filed on Jan. 31, 2007.

(51) Int. Cl. B42D 15/00

(52) U.S. Cl. 283/72

(57) ABSTRACT

A system for generating secure documents includes a station for generating a plain document and a security image generator that generates a security image. The security image is then incorporated into the plain document. Each security image consists of a plurality of secure elements, each secure element being defined by two sets of parallel lines. Each secure element defines an alphanumeric character or other unique image that is visible only under certain conditions, i.e., when inspected through a viewer. The technique can also be used to provide security images on a web page as a means of indicating that the web page is genuine.

### RELATED APPLICATIONS

This application is a continuation in part to application Ser. No. 11/678,318 filed Feb. 23, 2007, which claims priority to U.S. Provisional application Ser. No. 60/887,439 filed Jan. 31, 2007 all incorporated herein by reference in their entirety.

### BACKGROUND OF THE INVENTION

A. Field of Invention

This invention pertains to a system for producing certified documents electronically, and more particularly, to a system and method for producing documents that have a security image with information that is not visible to the naked eye, thus providing a certification that the document is genuine. The system is also used to generate web pages with a similar security image as a means of providing verification that the web pages are genuine. A method and system is provided wherein a string of alphanumeric characters are converted into a security image from several security elements, each element corresponding to each of the characters of the string. The string may be defined by a customer and may be different for each document, or it may be a standard string that is used for a number of documents or web pages.

B. Description of the Prior Art

The security of documents has been a long time concern, particularly for governmental agencies and financial institutions. In order to provide assurance that a document is genuine, documents have been printed on paper having special characteristics. For example, it is very common to provide official documents, including bank notes and financial instruments on paper that is embossed and/or imprinted with a fine design that is difficult to reproduce or copy. Moreover, some of the patterns imprinted on the paper are constructed and arranged to be almost invisible to the naked eye on an original document but produce a very clear mark when reproduced on a copier, thereby indicating that a corresponding document is not genuine but has been copied. Various techniques for generating these types of documents have been developed, for example, by Document Security Systems, Inc. of Rochester, N.Y.

However, until now these types of documents were mostly produced in one step using specialized expensive printers, or in two steps, first by imprinting or embossing blank pages with a security image or watermark, and then, by applying content to the pages. In either case, the process is slow and time consuming. Moreover the process is very expensive if it is used to produce a single, unique document that may be used, for example, for identification.

Attempts were also made to produce similar security images electronically using mathematical algorithms on a whole string of characters at once. However, these attempts were unsuccessful because they were too slow and inaccurate.

### SUMMARY OF THE INVENTION

The present invention pertains to a method and system for adding a security image to a document electronically. Embedded in the security image is a string of alphanumeric characters used to verify the authenticity of the document. Additional graphic elements can also be added to the string if desired. The security image is structured and arranged so that when the document is viewed normally on a monitor or when the document is reproduced on a standard printer, the string is substantially invisible to the naked eye. The system further includes means for viewing the security image to read the string.

The document with the security elements can be generated using various well known software programs. Once the security images are produced they are merged into a respective document and then the document can be stored and transmitted electronically. If the documents is in certain formats that do not translate images well between monitors and printers (e.g., documents in pdf or html formats), the security images converted using appropriate scaling factors.

### BRIEF DESCRIPTION OF THE DRAWINGS

FIGS. 1A-1D show the process used to generate a security image according to this invention;

FIG. 2 shows a system for incorporating security images into documents in accordance with the embodiment of the invention;

FIG. 3A-3C show how a document is modified by adding security images in accordance with this invention;

FIG. 4 shows a flow chart for generating security images and merging them with documents;

FIG. 5 shows a table for converting images from a standard monitor to images printed on either a 600 or 1200 DPI printer; and

FIG. 6 shows a flow chart for converting images compatible with monitors and printers.

### DESCRIPTION OF THE INVENTION

In one aspect, the present invention pertains to a method and system for providing a unique security image that is incorporated or embedded electronically into a document.

As discussed above, prior art techniques are known in which a paper used for a document is preprinted on a special printing press with a security feature. The security feature is generated from line patterns, including two sets of parallel lines disposed at a respective predetermined angle. The line patterns have characteristics selected so that when the document (or the preprinted paper) is copied on a standard copying machine, a preselected image and/or a string of alphanumeric characters appear on the copy. Alternatively, a special viewer formed of a hard of transparent material with a silk-screened line pattern can be used to view the original document. Alternatively a transparent film is printed with lines having a predetermined line spacing and angles cam be used. However, this technique cannot be used to generate documents electronically.

According to the present invention, a document with a security image is generated as follows. First, a library containing a set of security elements is provided, each element corresponding to an alphanumeric character. If necessary, other security elements may be incorporated into the set, such as elements representing the image of a face, or various articles. Each security element consists of at least two sets of parallel lines disposed at a predetermined angle and having a predetermined line density.

In the prior art techniques described above, a security feature was generated using line densities ranging from 100 LPI (Lines per Inch) up to 300 LPI or more, with 133 LPI being typical. However, the present inventors have found that this range is not particularly suited for electronically produced documents. For example, if a document is created with a security image having this density and then printed on a 600 DPI printer, then printer must generate a line every 600/133=4.5112 dots. However, a standard printer can not print a half a dot and therefore the line density used for preprinted documents is not suitable for electronically generated transmitted documents. The present inventors have determined that instead of 133 LPI, 75 LPI is more suitable. Then, a 600 DPI printer can be used to make the required lines easily. For example, a typical line pattern may be generated by printing a line one dot wide separated from the next line by a space equal to the width of several lines. For a 1200 DPI printer the line density can be increased to 150 LPI.

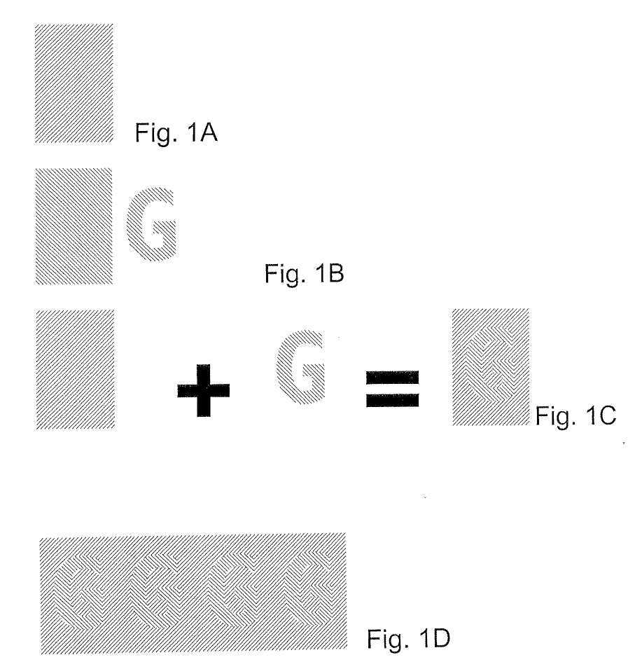

A technique for generating the security elements is now described. The security elements are generated electronically using a graphic program such as Photoshop, Gimp, etc. First a blank canvas is selected having a predetermined size. The canvas is then filled with a first set of parallel lines disposed at a first angle, as shown in FIG. 1A. In this figure the first line pattern has an angle of 45° forming the background for the canvas. Next, an alphanumeric letter is selected for which a security element is required. The letter has a predetermined font and can be an upper case or a lower case letter. The letter is filled with a second set of lines having a predetermined angle with the first set of lines. For example, the second set of lines may be perpendicular to the first set. In FIG. 1B, a capital G is shown filled with a second set of lines perpendicular to the first set. (In FIG. 1B, the second set of lines are shown on the right side of the letter G for the sake of clarity). Preferably, the two sets of lines have substantially the same characteristics (except for the angle). For example, both set of lines may be 1 dot (or pixel, as seen on a screen) wide and separated by 7 dots (or pixels). When printed, the sets of lines can have a line density of 100-175 lpi.

Next, the alphanumeric character (in this case, G) is merged or combined with the background canvas as shown in FIG. 1C. While this step is performed electronically, the resulting security element is inspected visually and one or both sets of lines of the security element are moved either up, down or laterally to insure that most of the lines of one set do not merely terminate at the interface between the letter and the background but that they are connected to respective lines of the second set, and that the security element does not have any voids or large dots at the interface. In some cases, individual lines may have to be extended (by adding pixels) or shortened (by eliminating pixels). This process insures that the security element looks homogeneous and that respective letter is difficult to see.

This process is repeated for every alphanumeric character desired, as well as for any other types of characters or images to complete the set of security elements. Moreover a library can be generated with several sets of alphanumeric characters, each having different fonts, sizes, etc.

Preferably, the set of security elements are stored as image elements in a library using any lossless graphic format, such as GIF, in a database.

This library can be accessible to generate documents as described below. The security elements are sized and arranged so that when several elements are put together side by side, the security elements are joined seamlessly with background lines of one security element being continuous with lines of the adjacent element. FIG. 1D shows a security image consisting of a row of four security elements generated in this a manner. In the Figure, each of the elements corresponds to the letter G, but as indicated above, any combination of alphanumeric elements can be combined to form a security image. (It should be understood that throughout FIGS. 1A-1D the thickness and density of the lines are exaggerated for illustration purposes.)

Once the set of security elements are formed, they can be used in a number of different ways in various systems. For example, an author generating a document using any standard application, such as a word processor, a spreadsheet, etc., may decide that at least some information on the document should be hidden from plain view or verified. For example, he may want to provide a verification that a commercial instrument has a face value of $10,000.00. Other such information may include serial numbers, passwords, secret information, etc. Therefore, one portion of the document may indicate in plain text the face value. To generate the other portion, he access the database, either directly, or via a web page, and request the corresponding composite images. The composite images are then incorporated into the document as a watermark, background or an imbedded image as described below.

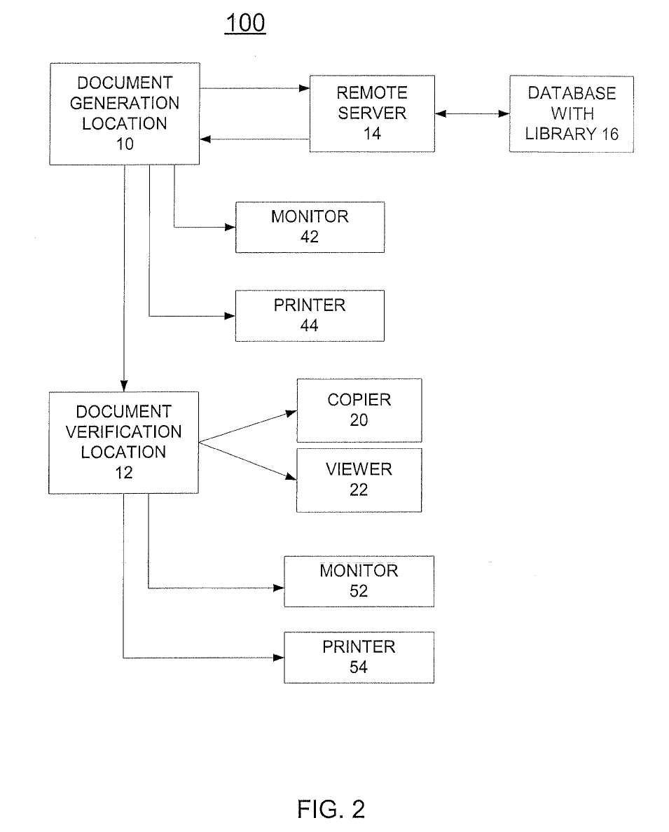

FIG. 2 shows a first system for generating documents using security images generates as described above. The system 100 in this Figure includes a document generation location 10 and a remote server 14. Server 14 is associated with a database 16 with a library of security elements generated as described above, and in FIGS. 1A-1C.

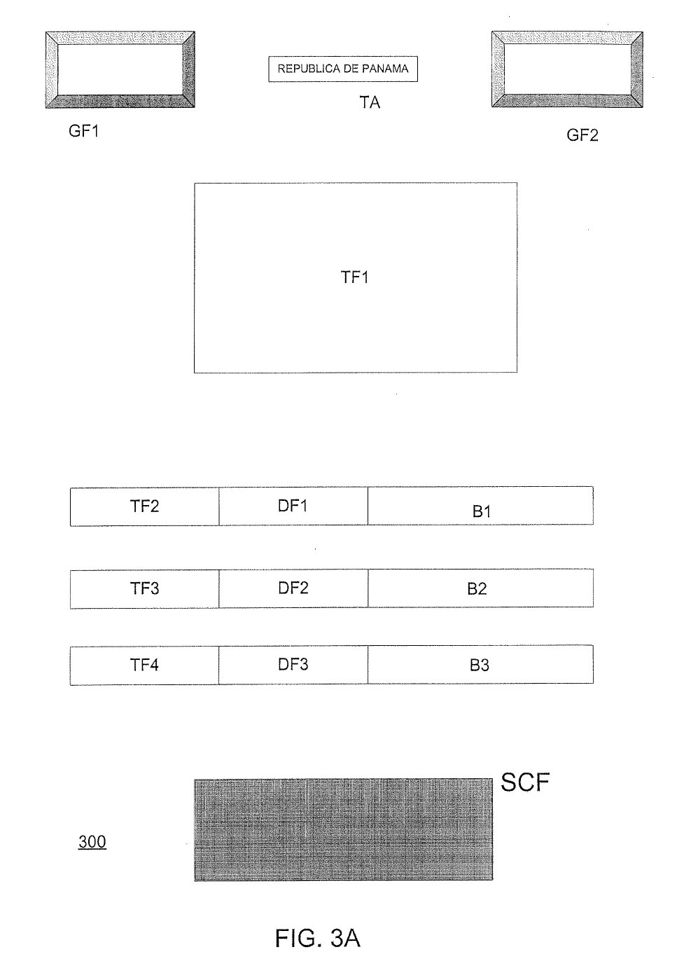

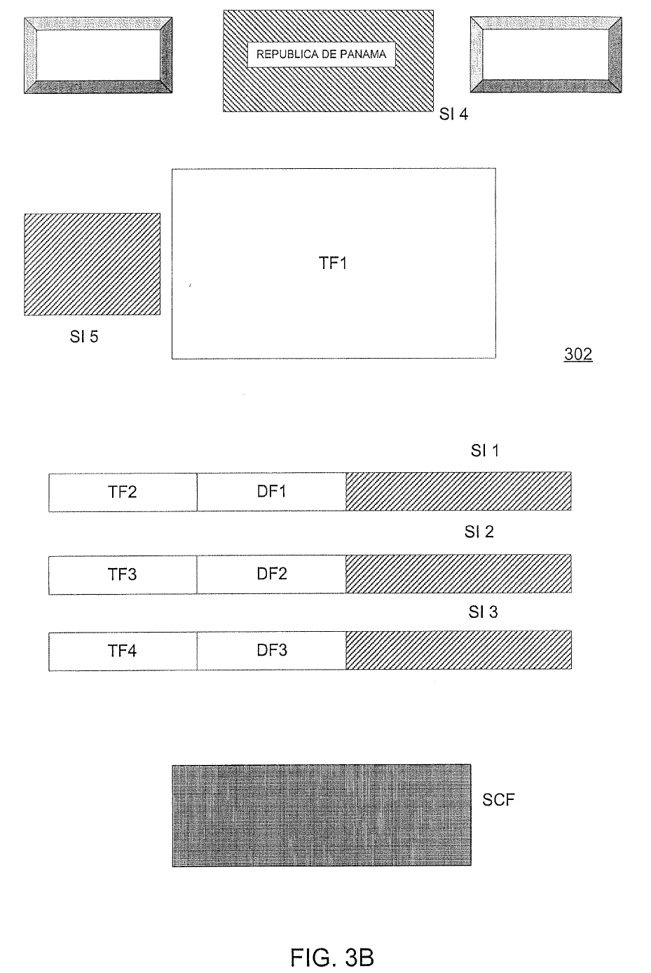

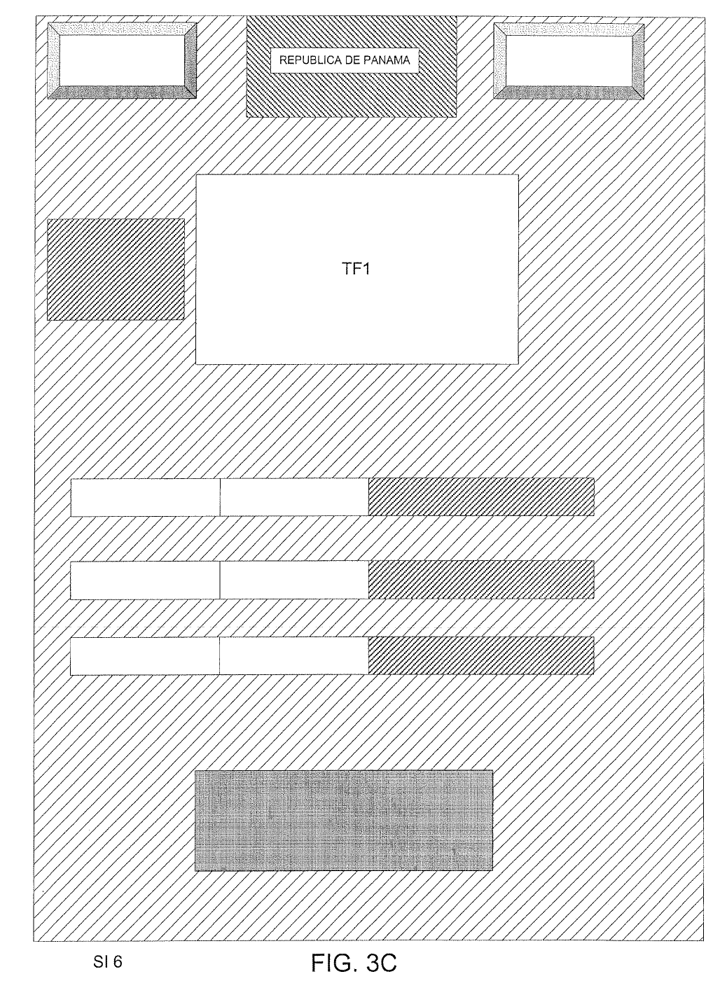

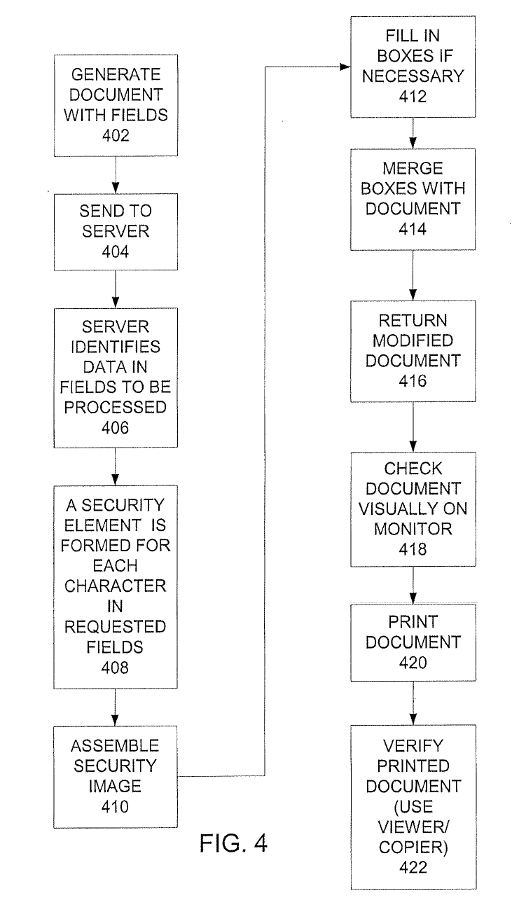

The system 100 further includes a document verification location 12 used for verifying that any received document is genuine and has been generated by, or at the document generation location 10. The operation of system 10 is now described in conjunction with FIGS. 2, 3A-3C and FIG. 4. The process starts with the generation of a standard or plain document 300, as indicated in Step 402 in FIG. 4 at the form generation location 10. An example of such a document 300 is shown in FIG. 3A and it includes several fixed text fields such as TF1, TF2, TF3, TF4 with various text, a title area TA identifying the document and/or the issuing authority, one or more graphic fields GF1, GF2 with pictures or other graphic elements and a security code field SCF, such as a bar code. Document 300 may be generated by using a template with these fields already populated or each of these fields may be added on the fly. Any of the fields described so far may have static content that is predetermined or may have dynamic content that is provided when the document is generated. In addition, the document 300 also includes several data fields DF1, DF2, DF3 that include data entered by an operator. These fields may define one or more dates, monetary amounts and/or other quantities, serial numbers, security codes, etc. Finally, the document has several fields B1, B2, B3 reserved for corresponding security images corresponding to the data in data fields DF1-DF3. Preferably, these fields are disposed adjacent to the respective data fields, but can be placed anywhere on the document.

The document 300 may be a certificate of citizenship, a license, etc. The document 300 can be generated on a data processing device such as a computer using standard software applications such as Microsoft Word, Microsoft Excel, Adobe Acrobat, etc. Preferably the user generating the document can see it on a monitor 42, and if necessary, can obtain a hard copy of it on a printer 44.

In one embodiment of the invention, in step 404 the generated document is sent to the remote server 14. The remote server identifies the data fields DF1-DF3 that require to be translated into corresponding images. This step can be performed by designating ahead of time the location of the data fields, by sending a separate data file indicating the content of the data fields or any other means. The data in these fields is in the form of an alphanumeric string. In step 408, the server accesses the library 16 and for each element of each string, it retrieves the corresponding security element. In step 410 the retrieved elements are arranged in sequence to form a corresponding security image for each string, the security elements matching seamlessly as illustrated in FIG. 1D. Therefore each security image is homogenous because it is formed of a plurality of continous lines with segments disposed at a predetermined angle to each other. In step 412 the size of the resulting security image is compared to the size of the respective B1-B3. If the security image does not fit the size of the respective field, each field may be resized as required. Alternatively, security image is resized.

In step 414 the security images are merged with the original document by replacing or overwriting the fields B1-B3 with the respective security images SI1-SI. The modified document 302 is shown in FIG. 3B. The modified document 302 is then returned to the location 12 (step 416). At the location, the modified document may be checked visually on a monitor 52 in step 418. However monitors used in Apple computer systems generate images at a resolution of 72 pixels per inch (PPI) and Windows-based systems use monitors use a resolution of 96 PPI and on both types of monitors the security image appears merely as some blurred lines. The actual alphanumeric characters embedded therein may be visible by using zooming on the monitor

Next, the modified document is printed (step 420) using any standard printer 54. The printed document, looks like what is shown in FIG. 3B.

The document can be authenticated or its contents may be verified at location 12 in two ways. First, the document can be inspected through a viewer (420). This viewer may be, for instance, through a piece of transparent material with lines having a density matching the density of the lines in the security images. When the security images are viewed in this manner, the alphanumeric characters become clearly visible. Alternatively, the characters may become readable when the document is photocopied on a copier 20.

Of course, different security images may be provided on other portions of the document. For example, as shown in FIG. 3B, the document can include a security image SI4 behind the title field (e.g., the security image becomes a background for the title field) and/or a security image SI5 can be positioned at any other location on the document. Moreover, a security image SI6 can be provided as a background or watermark for substantially the whole document as shown in FIG. 3C.

The security images SI4-SI6 can consist of fixed characters (identifying, for example, the name of the authority issuing the document) that are the same for all the document, or variables that are different for different users, different class of customers, etc. All the images S4-S6 are generated using any of the processes described herein.

In the embodiment described, document 300 is first generated, sent to the server, the security images are generated, merged into the document, and the modified document is then returned to the location 10. In an alternate embodiment, instead of sending the whole document, the station 10 sends to the server only the data fields or the string of characters requiring corresponding security images. In this case, the server returns the security images and the images are merged into the document at location 10.

In another embodiment, the server 14 is eliminated altogether. In this embodiment, the library of security elements is provided directly to the location 10. At this location, an author can have security images from the database and then assemble the security images as discussed above.

In another embodiment of the invention, the same process described above is used to protect, verify or otherwise authenticate a web page. In this embodiment, a plain web page is generated and a security image generated as discussed above is merged with the plain web page to form a modified web page. As in the previous embodiments, the security image contains a string of alphanumeric characters. A user can determine whether he is looking at a webpage thus modified is genuine or not by printing the webpage or any other documents associated therewith. The printed document includes the security image and can be checked for authenticity by using a viewer or by photocopying as described above. Alternatively data imbedded in the security image can be extracted using the same techniques.

Some applications, such as web pages cannot use the composite images in the formats and sizes in which they are stored. For these situations, in order to display a security image in a browser, a webpage designer needs to know the size of each security image. In the example given above, if the security image is opened in a browser in its default size, it may be too small or too large to see and print properly. In these cases, the developer needs to set the width and height of the security image on the monitor to scale the image. The image may look distorted on the display (similar to what is shown in FIG. 3B) but it may print perfectly.

A further problem is presented by a lack of compatibility between the way in which certain programs present images on a monitor as opposed to the way that the same images are printed. Most document authoring programs, such as programs used to generate text, including Word or Excel from Microsoft or WordPerfect from Corel, perform a conversion that insures the image of a document on a monitor looks the same as the image of the same document from a printer, using a WYSiWYG (What You See is What You Get) scheme of rendering images on a monitor. However, some programs do not perform this conversion automatically, and accordingly when images rendered by these programs on a monitor are then printed, they look distorted, and frequently are so small that they are unusable.

In order to overcome this problem, in the present invention, a conversion or scaling factor F is selected and used to convert images between a monitor and a printer, based on the characteristics of each. For example, as discussed above, a printer typically prints 600 DPI while images on a monitor may be rendered at 96 PPI. The conversion factor F between such two devices is 600/96=6.25. For a printer using 1200 DPI, the conversion factor is doubled (12.5). For a monitor set at 72 PPI, the conversion factor is 600/72=8.3333.

When an image is generated for a printer before it is rendered on a monitor, the image is processed to make a converted image using the appropriate conversion factor.

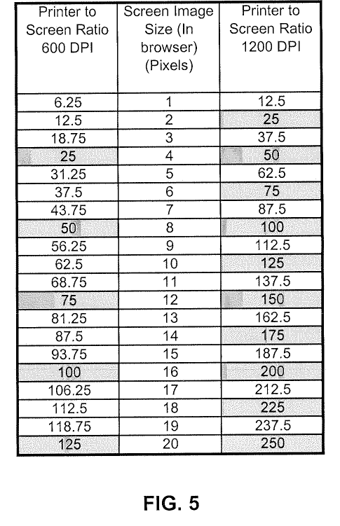

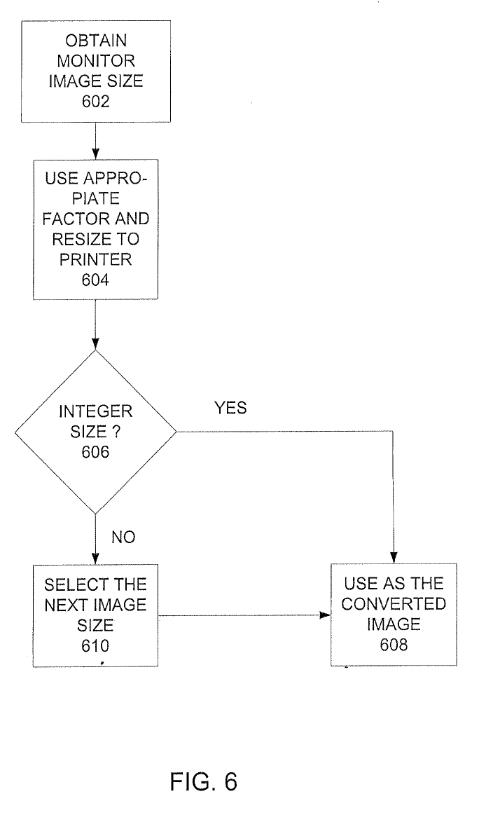

For example, as shown by the center column in FIG. 5, an image on a monitor can have an arbitrary size (in corresponding DPI). Using the respective conversion factors of 12.5 and 6.25, the right and left columns show the corresponding image sizes for a 1200 DPI printer and 600 DPI printer, respectively. In the present invention, the monitor image size is converted as illustrated in the flow chart of FIG. 6. In step 602 image size from the monitor is obtained. This is the image size that is listed in the middle column of FIG. 5. The column starts with 1 for the sake of completeness. Next, in step 604 the image is resized using the appropriate factor for the corresponding printer, as discussed above.

As can be seen in the table of FIG. 5, in most situations, the converted image has a fractional size (e.g., 68.75). In many instances this may not matter. However for the present invention, the images have to be rendered very accurately in order to insure that the lines are clean and no gaps appear between the lines that an angle with respect to other lines.

Therefore it is preferable if the converted images have integer sizes. For this purpose, in step 606 a test is performed to determine if the converted image from step 604 is an integer. If it, is then in step 608, it is used as the final converted image. If it is not, then it is enlarged to the next integer image size in step 610. This new image is then used as the converted image.

As can be clearly seen in FIG. 5, the allowable image sizes for 600 DPI printers correspond to the monitor sizes that are divisible by four. For the 1200 DPI printers the allowable image sizes correspond to even monitor sizes. For other monitor set-ups and printers, similar rules will be apply. In some instances the original images are sized properly for a printer but not for the associated monitor. In this case, the process discussed above is reversed.

In any event the conversion process presented herein insures that the images with security elements are properly rendered on the monitors of the system and the associated printers. Preferably the conversion process is performed by the server 14 in FIG. 2. Normally, during the conversion process the aspect ratio of each image (that is, the ratio between its height and width) is maintained. Once the modified security image is obtained by using the conversion factors discussed above, it is transmitted to the customer site were it can be imbedded into a document. The document with the imbedded security image can then be authenticated by looking at it through a viewer. The viewer has etched or printed lines at a line density and angle matching the line density of the lines of the security element. If the aspect ratio of the security elements is changed, then the line density if the security elements is changed as well and a different viewer has to be used to authenticate the document.

In another embodiment, after the security elements are created they must be imported into a secure database, to keep people from grabbing them and playing or altering them. The elements in the database are stored in binary format and are to be retrieved when needed.

A client will have a dedicated real-time service that will provide an output to a design and format that the client has agreed upon. This output will have both secure and insecure data. The client's request will be sent to the service that will print out their document. When the data is being compiled for printing, the process will take the security fields and will replace them with the security images, meaning that each security field will be parsed letter by letter and the service will replace each letter with the appropriate security image at a specific size (height and width) to get the best result.

Then the output will display the data requested along with the security images. Upon printing of this output, the security images will display their true form. After the printing has finished, the documents can be checked using the viewer and the text embedded in the security images can be read.

Numerous modifications can be made to this invention without departing from its scope as defined in the appended claims.

We claim:

1. A system for generating documents electronically comprising:
a document receiver receiving electronically a plain document; and
a security image generator generating a security image including a plurality of security elements arranged adjacent to each other, each security element being formed of at least two sets of parallel lines disposed at different angles and corresponding to at least an alphanumeric character; and
a modified document generator generating a modified document by merging said security image with said plain document.

2. The system of claim 1 further comprising a library for said security elements, said security image generator accessing said library to generate said security image.

3. The system of claim 1 further comprising a server remotely located from said document generator, said security image generator being incorporated in said server.

4. The system of claim 1 further comprising a verification station for detecting the alphanumeric characters in the security image.

5. The system of claim 1 wherein said security image includes security elements corresponding to a predetermined string of alphanumeric characters.

6. The system of claim 1 wherein said plain document includes data and wherein said security image includes security elements with a data string of alphanumeric characters corresponding to said data.

7. The system of claim 1 further comprising a processor, a printer printing a hard copy of said modified document at a first resolution and a monitor rendering an image of said modified document at a second resolution, wherein said modified document generator generates said document at one of said first and second resolutions and wherein said document processor processes said modified document to conform to the other of said first and second resolutions.

8. The system of claim 7 wherein said printer prints said document using a printer resolution and said monitor displays images at a monitor resolution and wherein said document processor processes said modified image based on said printer resolution and said monitor resolution.

9. The system of claim 8 wherein said processor scales said document using a scaling factor based on the ratio between said printer and said monitor resolution.

10. The system of claim 8 wherein said processor analyzes the processed image resulting from said modified image and allows rendering of one of said images only if the processed image has a resolution of an integer number.

11. A method of generating a secure document comprising:
generating a plain document;
generating a security image by assembling a plurality of secure elements, each secure element being formed of two sets of parallel lines disposed at different angles and arranged to define an alphanumeric character; and
merging said plain document and said secure image to form a secure document.

12. The method of claim 11 wherein the secure elements of said secure image define a predetermined string of alphanumeric characters.

13 The method of claim 11 wherein said plain document includes data specific to said plain document further comprising selecting the alphanumeric characters corresponding to said data as part of said string.

14. The method of claim 13 wherein said plain document includes a data field containing said data, further generating said string of alphanumeric characters based on said data field.

15. The method of claim 14 wherein said plain document is generated remotely, from said string, further comprising transmitting data from said data field to a security image generator for generating said security image.

16. The method of claim 11 further generating a library of said security elements.

17. The method of claim 16 further comprising generating said security elements by defining a canvas, filling said canvas with a first set of parallel lines, forming one of said alphanumeric characters with a second set of parallel lines and joining said first and second set of parallel lines.

18. The method of claim 17 further comprising adjusting the relative positions of said sets of parallel lines within a security element to insure that a substantial portion of said lines of said sets intersect each other.

19. The method of claim 18 wherein said first and second set of parallel lines are perpendicular to each other.

20. The method of claim 11 wherein said secure document is rendered on a monitor and a printer, further comprising scaling the secure document for a resolution compatible to one of a printer and a monitor resolution.

21. The method of claim 20 wherein said scaling factor is determined from a monitor resolution characteristic of said monitor and a printer resolution characteristic of said printer.

22. The method of claim 21 further comprising scaling the secure document to a resolution compatible with a monitor, determining a size of said scaled secure document, and displaying said scaled secure document only of said scaled secure document has an integer number of lines.

23. An apparatus for generating a security image corresponding to a string of characters comprising:
a processor receiving said string of characters; and
a database storing a library of security elements, each security element being formed of a homogeneous image corresponding to an alphanumeric character, said alphanumeric character being substantially invisible in said image;
wherein said processor selects a plurality of security elements from said library corresponding said string of characters and joins them seamlessly to form said security image.

24. The apparatus of claim 23 wherein said library holds images formed of two sets of parallel lines disposed at different angles.

25. The apparatus of claim 23 wherein said processor further sizes the security image to render it more visible on a monitor.

26. The apparatus of claim 25 wherein said processor sizes the security image based at least on one of a monitor and a printer resolution.

27. A method of generating a security image comprising:
providing a library of security elements, each element being formed of an image corresponding to an alphanumeric character, said alphanumeric character being substantially invisible in said image;
receiving a plurality of characters;
retrieving a plurality of security elements from said library, each retrieved element corresponding to one of said characters; and
joining said security elements to form a security image corresponding to said characters.

28. The method of claim 27 wherein said security elements are joined seamlessly.

29. The method of claim 28 wherein each security element is formed of sets of parallel lines disposed at respective angles, and wherein during the step of joining, lines from one security element form continuations of lines of an adjacent element.

30. The method of claim 27 further comprising scaling the security image for presentation on a monitor.

31. The method of claim 30 wherein said scaling is performed using a scaling factor dependent on the resolution of said monitor.
